(19) United States
(12) Patent Application Publication
(10) Pub. No.: US 2013/0270380 A1
(43) Pub. Date: Oct. 17, 2013

(54) SEAT BELT RETRACTOR COVER FOR WEBBING PROTECTION

(71) Applicants: Terrie Ellison, Hilliard, OH (US); Ross L. Burghardt, Marysville, OH (US)

(72) Inventors: Terrie Ellison, Hilliard, OH (US); Ross L. Burghardt, Marysville, OH (US)

(21) Appl. No.: 13/447,951

(22) Filed: Apr. 16, 2012

(51) Int. Cl. B60R 22/34

(52) U.S. Cl. 242/379

(57) ABSTRACT

A seat belt retractor assembly includes a housing that rotatably receives a spool in the housing. A seat belt webbing is connected to and wound around the spool for selective winding and unwinding therefrom as the seat belt webbing is extended and retracted relative to the housing. A cover is received on the frame housing and includes an integral clip adjacent a first edge configured to engage a mounting element. The cover has a sloping conformation that covers an open portion of the housing to prevent debris from passing through the housing and reaching the seat belt retractor mechanism or seat belt webbing.

### BACKGROUND

The present exemplary embodiment relates to a seat belt assembly, and more particularly to a protective arrangement for the seat belt, and associated method of protecting the seat belt. It finds particular application in conjunction with protecting a seat belt retractor and the seat belt webbing, and will be described with particular reference thereto. However, it will be appreciated that the present exemplary embodiment is also amenable to other like applications.

During installation of seat belts, for example in connection with front seat belts in an automotive vehicle, mounting bolts are occasionally mis-installed. More particularly, a mounting bolt is sometimes cross-threaded. To correct this problem, a corresponding nut on the vehicle body must be re-tapped. The resulting metal shavings from the re-tap process can cause additional problems. For example, the metal shavings may fall onto the seat belt webbing which is stored in a seat belt retractor housing. The retractor housing is typically an open, frame-like structure and thus the retractor mechanism and components, and seat belt webbing are potentially exposed during the re-tap process. As a result, metal shavings may drop into the retractor mechanism. The metal shavings may interfere with or jam relatively moving components of the seat belt retractor i.e., the metal shavings can hinder performance of the seat belt retractor.

Re-tapping the nut also potentially results in metal shavings dropping on to the seat belt webbing. The material that forms the seat belt webbing does not instantaneously shed the metal shavings. Likewise, extension and retraction of the seat belt does not necessarily remove the metal shavings from the material of the seat belt webbing. This is undesirable, particularly when the seat belt is extended and worn by the vehicle occupant.

Providing protection from debris such as re-tap shavings and preventing the metal shavings from becoming a problem associated with the seat belt retractor components or mechanism, or becoming inadvertently embedded on the seat belt webbing have not been adequately addressed. One proposed solution uses a foam protector that surrounds the retractor housing. However, the foam protector is difficult to install and does not adequately protect against the noted re-tap shavings issues.

Still another proposed solution uses a plastic cover. However, the plastic cover is difficult to secure to the seat belt retractor housing and requires a separate fastener(s) with associated increased cost to manufacture and related assembly issues.

Accordingly, a need exists for an inexpensive, reliable, easy-to-assemble solution to the re-tap shavings issues potentially associated with mis-installation at the factory that overcomes the above-noted problems in a simple, effective, and economical manner.

### BRIEF DESCRIPTION

A new cover is provided and serves as a protective shield to direct potential debris such as metal shavings away from the retractor housing and away from the seat belt webbing.

The cover includes a body dimensioned to overlie an opening in a seat belt retractor housing. A clip is formed in the body and has a configuration that engages a mount extending outwardly from the retractor housing. At least one fastener portion is formed on the body at a location spaced from the clip to secure the body to the seat belt retractor housing.

The body preferably has a sloped configuration that directs particle shavings away from the retractor housing and away from adjacent the opening in the seat belt retractor housing that receives the seat belt webbing.

In a preferred arrangement, the body is a single, unitary member.

The at least one fastener portion in one embodiment includes first and second fasteners extending outwardly from an inner face of the body for engaging spaced apart locations on the seat belt retractor housing.

In one arrangement, the clip includes first and second cooperating arms spaced apart by a preselected first dimension that enclose a recess having a second dimension formed in the body greater than the first dimension. The arms are preferably formed of a material allowing the aims to resiliently flex outwardly as the clip is advanced over the seat belt retractor mount and subsequently flex to the first dimension to retain the cover

A first portion of the cover body is dimensioned to overlie an opening along an upper region of the seat belt retractor housing, and a second portion extends substantially perpendicular to the first portion and is located along a second edge of the first portion spaced from the first edge.

The enlarged first portion may have a generally arcuate conformation that generally extends from the first edge to the second edge.

The fastener preferably includes first and second arms spaced from one another and adapted to flexibly engage a portion of the seat belt retractor housing.

A method of protecting at least one of a seat belt retractor mechanism and seat belt webbing from debris includes providing a cover dimensioned for receipt over an upper portion of a seat belt retractor housing. The method further includes securing a first edge of the cover to the housing with an integral clip, and securing a second edge of the cover, remotely spaced from the first edge, to the housing with an integral fastener.

The method preferably includes forming the cover, clip, and fastener as a one-piece component.

The method includes forming the cover to have a sloped upper surface for directing material that falls thereon away from the retractor housing.

A primary benefit of the present disclosure is the provision of a cover that effectively protects the seat belt retractor mechanism and the seat belt webbing stored therein from potential debris such as re-tap shavings.

Another advantage relates in the simplified design and ease of assembly of the cover.

Still other benefits and advantages may become apparent to one skilled in the art upon reading and understanding the following detailed description.

### BRIEF DESCRIPTION OF THE DRAWINGS

FIG. 1 is a perspective view of a seat belt retractor housing with selected components removed for ease of illustration.

FIG. 2 is a perspective view of the seat belt retractor housing of FIG. 1 with the cover shown in disassembled relation.

FIG. 3 is a cross-sectional view taken generally along the lines 3-3 of FIG. 2.

### DETAILED DESCRIPTION

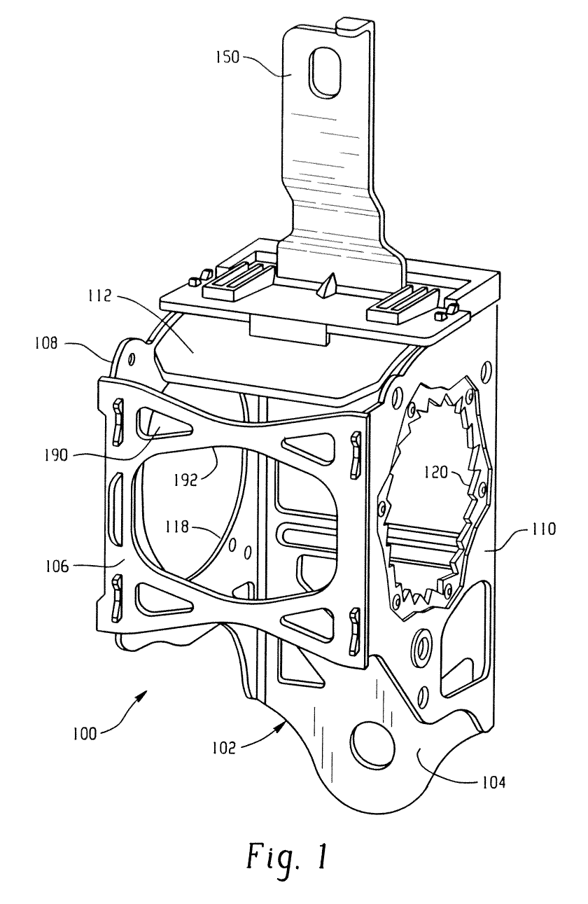

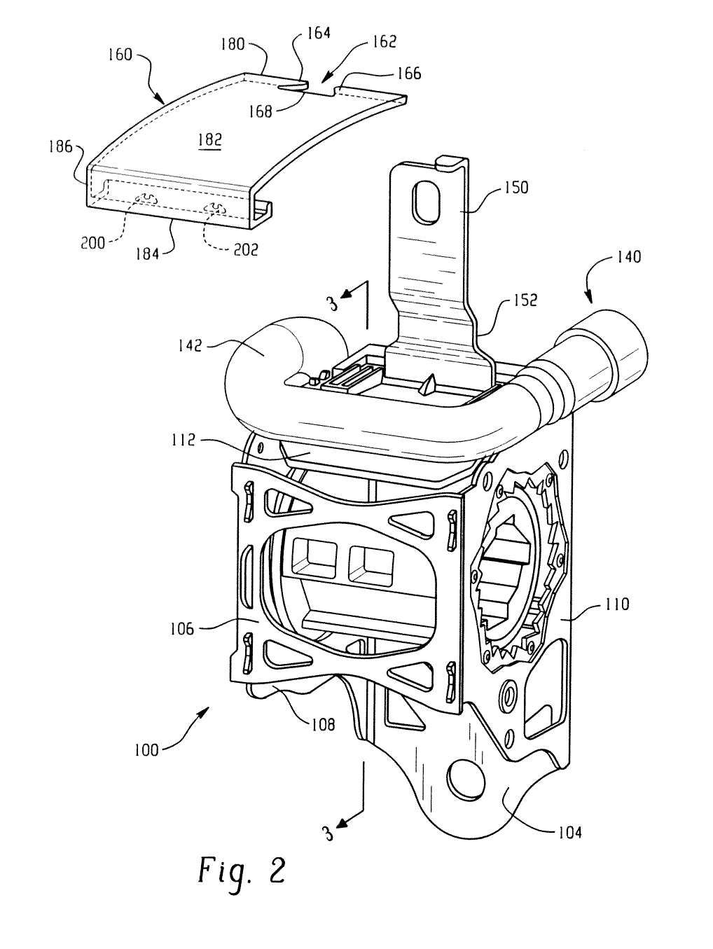

With reference to FIGS. 1 and 2, there is shown portions of a seat belt retractor assembly 100. The seat belt retractor assembly 100 includes a housing 102, sometimes referred to as a frame or frame-like housing, that includes for example a first wall or rear wall 104, a second wall or front wall 106, third and fourth walls or side walls 108, 110, and a fifth walls or upper wall 112. As perhaps best exemplified in FIG. 1, the walls 102-112 have a frame-like structure (i.e., there are openings in the walls) to reduce the weight and also accommodate different internal components of the seat belt retractor assembly 100. These components and their structural arrangement and functions are well known to those skilled in the art so that description herein is neither necessary nor required for a full and complete understanding of the present disclosure.

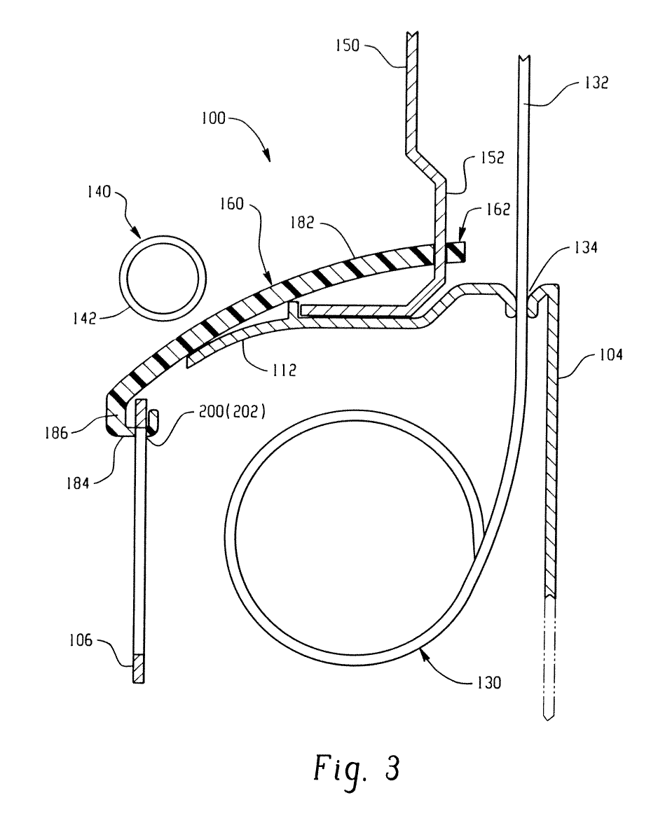

The side walls 108, 110 each include an enlarged opening 118, 120, respectively, that generally aligns with opposite ends of the winding shaft or spool 130. A seat belt webbing 132 is secured to an outer periphery of the spool in a conventional manner, i.e., the seat belt webbing is wound about the outer surface of the spool, and the webbing is selectively extended or retracted when the seat belt is used. A tension bar (not shown) is received through the hollow central portion of the spool to suppress rotation of the spool under certain vehicle events. The remainder of the structure such as a spring, locking pawl, etc. that aid in rotation or locking of the spool in a seat belt withdrawing direction are not illustrated for ease of reference. The seat belt webbing 132 is selectively deployed as the spool rotates in a first direction (counter-clockwise as illustrated in FIG. 3) and withdrawn through an opening 134 in the upper wall 112, and likewise retracted in an opposite direction or rotation of the spool. Further, a pretension assembly 140 includes a tubular structure or pipe 142 that is also secured to the housing so that pretensioner components such as a piston, balls, etc. provide for the desired pretension action of the seat belt mechanism. Again, further structural and functional details of the pretensioner and other aspects of the seat belt mechanism are known to those skilled in the art and are omitted for ease of reference and understanding.

Extending upwardly from the upper wall 112 is a seat belt stay or mount 150. The mount 150 has a base portion 152 that receives a cover 160. More particularly, the cover 160 has an integral clip 162 preferably defined by first and second arms 164, 166 that are spaced apart a first, preselected dimension in a relaxed, unbiased state. Preferably the cover 160 (and likewise the arms) is formed of a material such as a polymer or plastic, rubber, or co-injected plastic-rubber combination, that can be easily molded so that the arms 164, 166 will flex in a resilient and elastic manner to extend around the width of the base portion 152. A recess 168 spaced inwardly into the cover from the arms 164, 166 and the recess has a second dimension larger than the first dimension between terminal, inner ends of the arms 164, 166. Once the integral clip is advanced over the base portion 152 of the mount 150, a first edge 180 of the cover is effectively secured to the seat belt retractor housing.

A main body 182 of the cover has a generally sloped or arcuate conformation (perhaps best seen in FIGS. 2 and 3). In the preferred arrangement, the arcuate conformation extends substantially over the entire extent of the body from the first edge 180 to an opposite, second edge 184 of the body that forms the cover. Adjacent the second edge is a second or down-turned portion 186 that is substantially perpendicular to the arcuate conformation of the remainder of the cover body. The down-turned portion 186 has a generally J-shape configuration in cross-section (FIG. 3) that allows the downturned portion 186 to secure to the wall 106, particularly in openings 190, 192 formed in the wall. At least one flexible fastener, and more preferably first and second fasteners 200, 202, secure the opposite, second edge 184 of the body to the retractor housing. Thus as illustrated in the mounted position of FIG. 3, the integral clip 162 is received around a base portion 152 of the mount 150. The arcuate conformation 182 leads toward the second portion 186 so that any debris such as metal shavings that may fall from above during the re-tap process will not fall through any openings in upper wall 112, but rather will contact the cover 160 and be directed harmlessly away from the retractor housing, and away from the seat belt webbing 132. In this manner, the mechanism of the seat belt retractor and the seat belt webbing 132 are advantageously protected by the cover 160.

Preferably the cover is a one-piece, unitary structure with integrated clip and fastener. This provides for ease of manufacture and assembly, and likewise eliminates issues associated with using separate fasteners, such as inventory, assembly, etc. The cover has a generally rectangular shape, although other shapes can be used without departing from the scope and intent of the present disclosure. Similarly, although plastic is one desired material of construction, other materials that satisfy various desired properties (e.g., ease of manufacture, cost, ability to adopt various shapes, flexibility/elasticity for ease of assembly, strength, etc.) can be used to form the cover.

The exemplary embodiment has been described with reference to the preferred embodiment. Obviously, modifications and alterations will occur to others upon reading and understanding the preceding detailed description. It is intended that the exemplary embodiment be construed as including all such modifications and alterations insofar as they come within the scope of the appended claims or the equivalents thereof.

It is claimed:

1. A cover for an associated seat belt retractor comprising:
a body dimensioned to overlie an opening of an associated seat belt retractor housing;
a clip formed in the body having a configuration that engages a mount extending outwardly from the retractor; and
at least one fastener portion formed on the body at a location spaced from the clip that secures the body to the associated seat belt retractor housing.

2. The cover of claim 1 wherein the body has a sloped configuration that directs particle shavings away from the retractor housing and away from adjacent the opening in the associated seat belt retractor housing that receives webbing therethrough.

3. The cover of claim 2 wherein the body is a single, unitary member.

4. The cover of claim 1 wherein the at least one fastener portion includes first and second fasteners extending outwardly from an inner face of the body for engagement at spaced apart locations with the associated seat belt retractor housing.

5. The cover of claim 1 wherein the clip includes first and second cooperating aims partially enclosing a recess formed in the body, the arms spaced apart by a preselected first dimension that is less than a second dimension of the associated retractor stay that receives the clip.

6. The cover of claim 5 wherein the arms are formed of a material that allows the arms to resiliently flex outwardly to the second dimension as the clip is advanced over the associated retractor mount, and subsequently flex to the first dimension to retain the body.

7. The cover of claim 1 wherein the body has an enlarged first portion that is dimensioned to overlie the opening along an upper region of the associated seat belt retractor housing, the clip located along a first edge of the first portion, and a second portion extending substantially perpendicular to the first portion and located along a second edge of the first portion spaced from the first edge.

8. The cover of claim 7 wherein the enlarged first portion has a generally arcuate conformation from the first edge to the second edge.

9. The cover of claim 8 wherein the at least one fastener portion includes first and second arms spaced from one another and adapted to flexibly engage a portion of the seat belt retractor housing and secure the second portion to the seat belt retractor housing.

10. The cover of claim 9 wherein the at least one fastener portion has a generally J-shaped projection forming a bight region that is dimensioned to wrap around an associated wall of the seat belt retractor housing.

11. The cover of claim 10 wherein the cover is a one-piece component.

12. A method of protecting at least one of a seat belt retractor mechanism and seat belt webbing from debris comprising:
providing a cover dimensioned for receipt over an upper portion of a seat belt retractor housing;
securing a first edge of the cover to the housing with an integral clip; and
securing a second edge of the cover, remotely spaced from the first edge, to the housing with an integral fastener.

13. The method of claim 12 wherein the providing step includes forming the cover, clip, and fastener as a one-piece component.

14. The method of claim 12 wherein the providing step includes forming the cover to have a sloped upper surface for directing material that falls thereon away from the housing.

15. The method of claim 12 wherein the providing step includes molding the cover from a polymer material.

16. The method of claim 12 wherein the securing steps include elastically deforming the clip and fastener to mount the cover to the seat belt retractor housing.

17. A seat belt retractor assembly comprising:
a frame housing;
a spool rotatably received in the frame housing;
a seat belt webbing connected to the spool for selective winding and unwinding therefrom as the seat belt webbing is extended and retracted relative to the frame housing; and
a cover received on the frame housing including an integral clip having adjacent a first edge configured to engage a mounting element, and a sloping conformation that covers an open portion of the frame housing to prevent debris from passing through the frame housing and reaching the seat belt webbing or a seat belt retractor mechanism.

18. The assembly of claim 17 further comprising at least one fastener portion formed on the cover at a location spaced from the integral clip that secures the cover to the seat belt retractor frame housing.

19. The assembly of claim 17 wherein the integral clip includes first and second spaced arms by a preselected first dimension that partially encloses a recess formed in the cover that has a second dimension greater than the first dimension.

20. The assembly of claim 17 wherein the cover is a single, unitary plastic body.
